(19) United States
(12) Patent Application Publication
(10) Pub. No.: US 2020/0053037 A1
(43) Pub. Date: Feb. 13, 2020

(54) MESSAGE DELIVERY SYSTEM WITH SENDER-DEFINED OPENING TIME

(71) Applicant: Pradeep Singh, McLean, VA (US)

(72) Inventor: Pradeep Singh, McLean, VA (US)

(21) Appl. No.: 16/533,739

(22) Filed: Aug. 6, 2019

Related U.S. Application Data
(60) Provisional application No. 62/715,592, filed on Aug. 7, 2018.

(51) Int. Cl. H04L 12/58

(52) U.S. Cl. CPC H04L 51/18; H04L 51/22; H04L 51/24; H04L 51/10

(57) ABSTRACT

Embodiments of the present invention include a multi-user futuregram system, which enables users to instantly send and receive electronic messages, the contents of which cannot be viewed by one or more recipients until a specified date and time in the future. Futuregrams can include text, images, audio, video, and any combination thereof, as well as metadata. The system can automatically notify recipients when futuregrams are delivered and when the futuregrams can be viewed.

This application claims the benefit of U.S. Provisional Patent Application 62/715,592, filed 7 Aug. 2018.

### BACKGROUND AND SUMMARY OF THE INVENTION

People often make predictions and speculations about those around them, but never express their thoughts to anyone else for various reasons. For instance, a parent may strongly believe that his or her child will be accepted to a great college, but they may not want to say anything until the admission letter arrives to avoid putting additional pressure on their child. Upon receipt of the good news, it may seem somewhat dubious, if not outright disingenuous, for the parent to claim that they “knew” it all along.

In other circumstances, people often think about important events like birthdays and anniversaries before they arrive, but completely forget about them on the day they happen. They might set reminders on their phone only to miss them among a deluge of other reminders, or they may simply find themselves too busy to take any action.

In still other circumstances, people may have important news that they want to share with others, but they may want to build anticipation for the news over a period of days or weeks. For example, a musical artist may want to announce a new album or tour, and she wants her fans to get excited about the prospect of the news before the actual announcement.

All the above can be addressed with an invention that permits a sender to deliver a message to one or more recipients instantly, but the recipient(s) will not be able to view the contents of the message until a specified date and time in the future. Such a mechanism can convey the sentiment that the sender was thinking about the recipient, be a failsafe for important events, and/or arouse curiosity and excitement about the contents of the message.

Accordingly, embodiments of the present invention are directed to methods of configuring and delivering a “futuregram,” which is a message that will be delivered instantly (the “delivery time”) to one or more recipients, but which may only be opened on a specified date and time in the future (the “opening time”). In the same or alternative embodiments, the sender may also configure the delivery time to be some specified date and time in the future, provided it is before the opening time.

In embodiments, a new futuregram may be configured to include a message, the delivery time, the opening time, and the intended recipient(s). The message may include text, images, audio, video, or any combination thereof. A futuregram may also include other metadata, such as a theme (e.g., selected from among a plurality of predefined choices), one or more hints about what the message is or says, whether the futuregram is to be delivered anonymously, and whether the futuregram is intended to be public or private.

Embodiments of the invention also include other inventive features and functionality described in more detail below.

### BRIEF DESCRIPTION OF THE DRAWINGS

The invention is explained in further detail, and by way of example, with reference to the accompanying drawings wherein:

FIG. 1 illustrates a block diagram of an embodiment of a multi-user futuregram system.

FIG. 2 illustrates a block diagram of a workflow for creating a new futuregram.

FIGS. 3A-3H illustrate embodiments of client software for creating a new futuregram.

FIG. 4 illustrates an embodiment of client software for viewing futuregrams that have been sent.

FIG. 5 illustrates an embodiment of client software for viewing futuregrams that have been received.

### DETAILED DESCRIPTION

In the following description, for purposes of explanation rather than limitation, specific details are set forth such as the particular architecture, interfaces, techniques, etc., to provide a thorough understanding of the concepts of the invention. However, it will be apparent to those skilled in the art that the present invention may be practiced in other embodiments that depart from these specific details. In like manner, the text of this description is directed to the example embodiments as illustrated in the Figures, and it is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

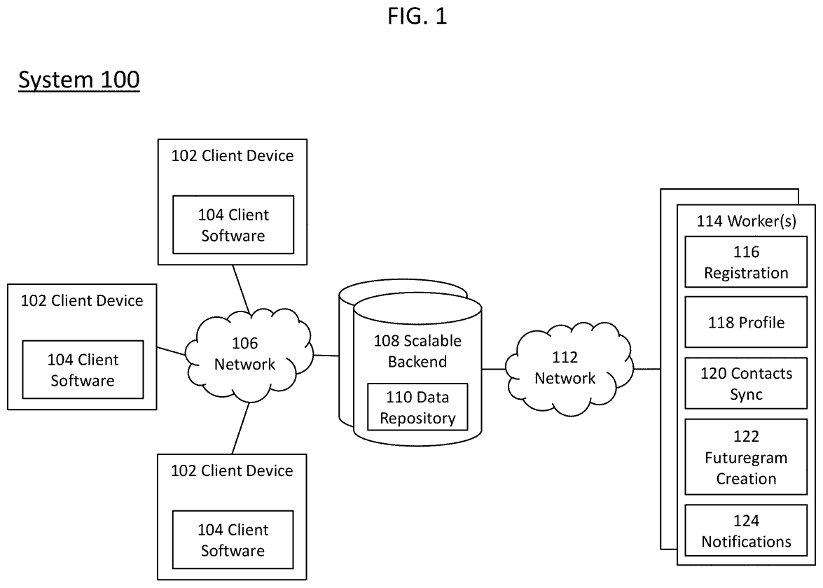

As illustrated in FIG. 1, embodiments of the invention include a multi-user futuregram system 100, which includes a plurality of client devices 102, one or more networks 106, 112, a scalable backend 108 with a data repository 110, and a server system with one or more virtual workers 114. In such embodiments, the multi-user system comprises client software 104 executing on each of the client devices.

In embodiments, client devices 102 are mobile phones (e.g., running Google Android or Apple iOS operating systems), tablets, or similar consumer devices. Client devices 102 can also be desktop or notebook computers (e.g., running Windows or MacOS operating systems), or other devices capable of executing software applications like web browser software.

In embodiments, client software 104 is a mobile application (e.g., an “app” on the Google Play Store or Apple App Store), a desktop application, or a cloud-based application that, for example, executes within a web browser. Client software 104 enables users to create and open futuregrams, among other functionality described herein. Client software, for example, may be written in JavaScript or any other programming language supported by client devices 102.

In embodiments, client devices 102 interact with the scalable backend 108 via network 106. In embodiments, network 106 is the Internet, but can be any other type of network capable of supporting communications between the client devices 102 and the scalable backend 108.

In embodiments, scalable backend 108 can be a conventional server system or a cloud-based server system (e.g., Amazon Web Services). Scalable backend 108 may include one or many devices and may be configured to grow (i.e., make more computing resources available) according to the number of client devices 102 in system 100. Scalable backend 108 includes a data repository 110 and provides services such as authentication, real-time database operations, file storage, and analytics. Client software 104 uses these services to, for example, authenticate users, store user data and files, and track user actions. The real-time database service provided by scalable backend 108 ensures that all its connected clients stay current with changes to the underlying data. All instances of client software 104 are clients of the real-time database. Data repository 110 can be one or more storage devices on one or more servers configured to store data in support of system 100.

In embodiments, scalable backend 108 communicates with server system 114 via network 112, which can be the Internet or any other type of network capable of supporting communications between scalable backend 108 and server system 114. In embodiments, scalable backend 108 and server system 114 are part of the same system, and network 112 is not needed.

In embodiments, server system 114 includes a plurality of virtual workers like registration 116, profile 118, contacts sync 120, futuregram creation 122, and notification 124. Virtual workers perform background jobs such notifying users of events (e.g., receipt of a new futuregram, a futuregram is ready to open, etc.), creating thumbnails of user profile pictures, etc. There is a different worker for each kind of background task that is performed by server system 114. In embodiments, each of the workers is also a client of a real-time database running on scalable backend 108, and the client software 104 creates tasks and receives results from the workers via the real-time database.

In embodiments, after installing the client software 104 on client device 102, a first-time user of system 100 registers (i.e., creates a new account) using an email address or other conventional authentication method. Registration can occur within client software 104 and/or on a website connected to or included within scalable backend 108. User registration is processed and saved to scalable backend 108 using registration worker 116. During registration, the user can provide additional profile information like a username, profile picture, birthdate, bio, etc. The user can later edit their profile information as desired. User profile information is processed and saved to scalable backend 108 using profile worker 118. A fully registered user can then send and receive futuregrams.

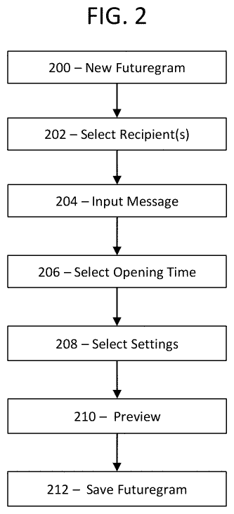

Embodiments for creating a new futuregram within client software 104 are illustrated by the workflow in FIG. 2. At step 200, a user indicates that they wish to create a new futuregram, for example by selecting a “new” or “create” graphical user interface (“GUI”) button within client software 104. At step 202, the user enters one or more recipients for the futuregram. In embodiments, a user can select recipients from a list of existing contacts, or one or more new contacts can be added at this time. The user can select existing contacts from one or more of: a list maintained by client software 104, a contact list stored on client device 102 (e.g., a mobile phone contact list), and a contact list maintained by scalable backend 108 of other users of system 100. Contact information can include an email address and one or more other parts of user profile information. Contact information maintained by scalable backend 108 is processed and saved by contacts sync worker 120. In embodiments, at step 202, instead of selecting one or more recipients, the user can select a social media platform (e.g., Twitter) to which the user can post the futuregram.

At step 204, the user inputs a new message for the futuregram. The contents of the message can comprise one or more of: text, images (including icons, emoticons, GIFs, etc.), audio, video, documents, files, and hyperlinks. The message can include a subject line, which in some embodiments can be visible to the recipient(s) even before the opening time. In embodiments, the user can also select a theme for the futuregram. A theme can define the look and feel of the futuregram, including the look of GUI elements like the background image, background color, font, font size, font color, and the arrangement of GUI elements within the futuregram. Themes, for example, can reflect the mood of the creator or may complement the sentiment associated with the futuregram. Client software 104 can provide a set of predefined themes, and the user can create new themes and edit existing themes. In embodiments, the user can also define one or more hints for the futuregram using client software 104. Each hint provides incrementally more information about the contents of the message without revealing the whole message. As discussed below, recipients can later request hints from the user.

At step 206, the user selects the opening time, i.e., the date and time after which the recipient(s) will be permitted to open and view the futuregram. In embodiments, the user may optionally select a delivery time as well, i.e., the time at which system 100 notifies the recipient(s) of a new futuregram. By default, the delivery time is “immediate,” i.e., the time at which the user finishes creating the futuregram.

At step 208, the user can select one or more additional settings for the futuregram. For example, the user can select whether the futuregram is anonymous (i.e., the recipients will not know the sender). By default, the recipient(s) will see the sender's identity at delivery time and opening time. The user can also select whether the futuregram is private or public. A private futuregram can only be seen by the specified recipient(s), while a public futuregram may, for example, appear on a website of most popular futuregrams and/or be shared with other users without restriction. In embodiments, users may be able to search for and view public futuregrams.

At step 210, the user can preview the futuregram based on all their inputs and selections thus far. In embodiments, the user can edit some or all of the properties of the futuregram at this step. For example, the user may elect to change the background image. Alternatively, the user can go back to earlier steps in the process to make desired changes.

At step 212, the user saves the futuregram. Futuregrams are processed and saved to scalable backend 108 by futuregram creation worker 122.

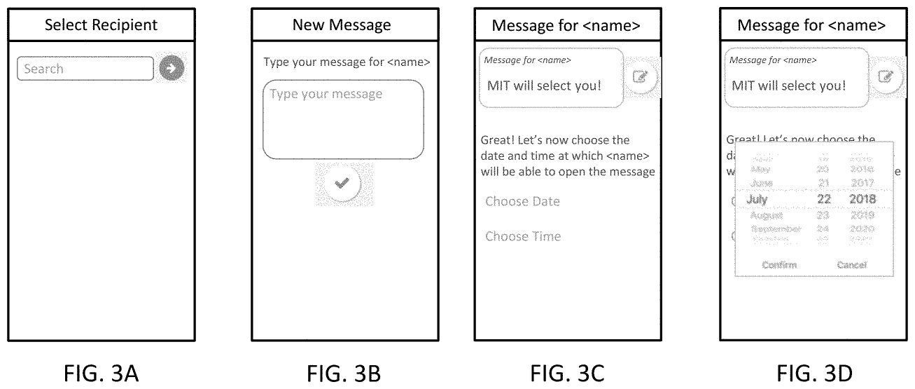

FIGS. 3A-3H illustrate example embodiments of client software 104. In FIG. 3A, a user can select one or more recipient(s), for example, by searching a list of contacts. The user can enter part of the recipient's name, email, username, etc. and client software 104 will populate the screen with matching contacts.

In FIG. 3B, a user can enter the message they wish to include in the futuregram and then select the checkmark button to advance to the next step.

In FIG. 3C, a user can view the message they entered and select the opening time for the futuregram. FIGS. 3D and 3E illustrate example date and time pickers, by which the user can select the opening time.

In FIG. 3F, a user can view the message they entered as well as the opening time they selected. They can also choose to preview the futuregram as it will appear to the recipient(s).

In FIG. 3G, a user can view the preview of the futuregram and choose to make any final edits including, for example, changing the background image. Once the user is satisfied with their futuregram, they can select “save” to complete the process.

In FIG. 3H, a user can see that their futuregram has been created and is being saved to scalable backend 108.

After a new futuregram is created and saved to scalable backend 108, the recipient(s) is/are notified at the delivery time (i.e., immediately or at some specified time in the future that is prior to the opening time). Notification worker 124 interfaces with scalable backend 108 to generate delivery notifications. In embodiments, notification worker 124 automatically generates and sends a delivery notification as one or more of: an email message, an SMS message, an in-app message (i.e., a message within client software 104), a push message (e.g., an app-driven pop-up message on a mobile device), a social media message (e.g., a Facebook Post), or any other digital messaging service. In embodiments, a delivery notification at least includes a message that a new futuregram has been sent to the recipient(s), and that the futuregram may be opened at the opening time. The notification may include additional information based on the respective futuregram's settings. For example, if the futuregram is not anonymous, the notification may identify the sender. The notification may also include some content associated with the corresponding theme. Some notifications, e.g., in-app notifications, may include a blurred representation of the full futuregram contents. In other words, the contents will be obfuscated enough that the recipient(s) cannot make sense of them.

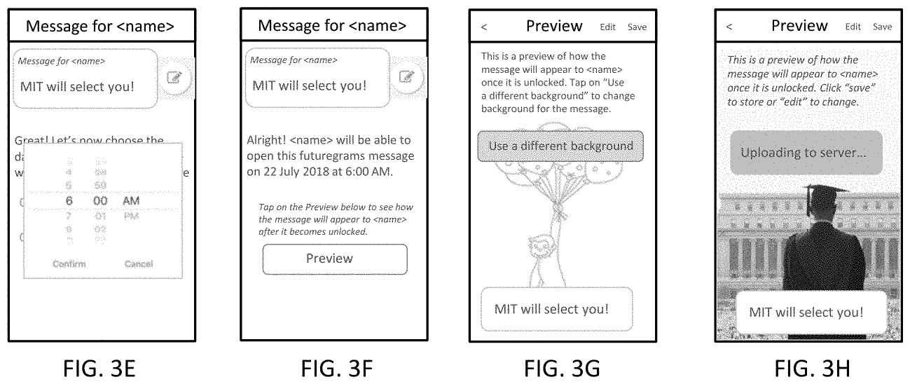

In embodiments, users can view within client software 104 a list of the futuregrams that they have sent. FIG. 4 illustrates such an embodiment with two sent futuregrams, each including the corresponding message subject and opening time. The user can select a sent futuregram to view it and interact with it.

In embodiments, system 100 provides numerous functions for senders and recipients between the delivery time and the opening time. For example, in some embodiments, the sender may edit one or more aspects of the futuregram (e.g., the message, background, media, settings, etc.) prior to the opening time. Notification worker 124 can automatically notify the recipient(s) as described above whenever changes are made to the futuregram. In embodiments, changes to a futuregram are logged so that recipients can optionally see all the changes after the opening time.

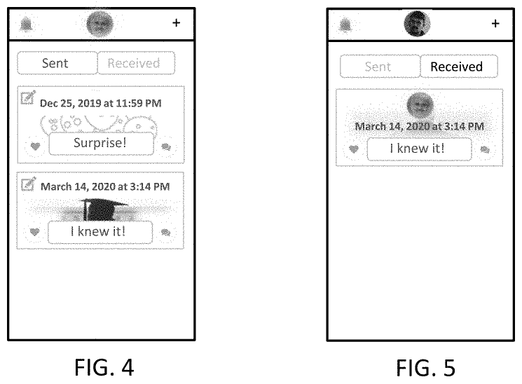

In embodiments, recipients of one or more futuregrams can view within client software 104 a list of the futuregrams that they have received as well as those public futuregrams that they have elected to follow. FIG. 5 illustrates such an embodiment with one received futuregram showing the message subject and the opening time. The list of futuregrams can be sorted in numerous ways, including for example, based on whether the futuregrams have been opened and whether the recipient is an original recipient or a forwarding recipient. From here, recipients can perform all of the functions available to them for respective futuregrams as discussed herein.

Senders and recipients can also engage in dialog (when the sender is known) about a particular futuregram. In embodiments, client software 104 can provide commenting capabilities and/or chat functionality in the context of a selected futuregram. With this functionality, a recipient, for example, might request hints about the contents of the futuregram. Client software 104 can include a “request hint” function that when selected by a recipient automatically generates a notification to the sender requesting more information about a futuregram. In the same or alternative embodiments, if the sender already defined one or more hints using client software 104 prior to the opening time, notification worker 124 could automatically provide one or more of the hints as a notification to the requesting recipient. In embodiments, comments about a futuregram may be hidden from everyone, or everyone but the sender, until after the opening time.

In embodiments, recipients may share futuregrams marked as public by the sender with other users. For example, a recipient may choose to forward a futuregram to a friend. In such embodiments, notification worker 124 would then automatically generate a notification as discussed above to be delivered to the new forwarding recipient. The forwarding recipient would then have the same privileges and capabilities with respect to the futuregram as the original recipient (i.e., they could not view the futuregram until the opening time, they can forward the futuregram to other users, and they can comment on the futuregram or utilize the chat functionality).

In embodiments, a recipient may elect to mute a futuregram (i.e., ignore any notifications and comments about the futuregram until the opening date), block the sender (i.e., prevent new futuregrams from appearing from the blocked sender), or delete a futuregram entirely.

In embodiments where a futuregram is publicly visible to all users (i.e., including non-recipients), each user could search for and interact with the futuregram in the same way that a recipient could. In the same or alternative embodiments, recipients may have more privileges than non-recipients, and/or original recipients may have more privileges than forwarding recipients. For example, non-recipients may have an opening time that is 1 hour later than recipients. Or original recipients may be able to comment about a futuregram, while forwarding recipients can read comments but not add their own.

At the opening time, notification worker 124 will automatically generate opening time notifications to the recipients in the manner(s) discussed above. An opening time notification alerts the recipient(s) that the full contents of the futuregram are available for inspection via the client software 104. In embodiments, the opening time notification can itself include the contents of the futuregram.

In embodiments, the opening time can be rule-based, i.e., the opening time is determined according to certain conditions being met. For example, a sender could configure a futuregram's opening time to be the time when there is a total of 1,000 recipients and forwarding recipients of the futuregram. In this manner, the original recipients would be incentivized to share the futuregram with other users in order view the contents of the futuregram. In other embodiments, the futuregram may include a puzzle that is visible at the delivery time, but the contents of the futuregram can only be viewed when one or more recipients solves the puzzle. In still other embodiments, some recipients may have earlier opening times than other recipients based on the completion of certain tasks (e.g., a threshold number of forwards or comments).

As discussed above, embodiments include permitting the sender to specify a social media platform as the recipient (i.e., sharing a futuregram with another social media platform). Even if a social media platform is not set as an original recipient, the sender or any recipients could later share the futuregram to social media using share functionality within client software 104. In such embodiments, a virtual worker (e.g., a social media worker) could send a post or message to the social media platform via its respective application programming interface (“API”). The initial post or message would resemble a delivery notification, informing followers of a new futuregram. Such followers could then find the futuregram on their respective instances of client software 104 or a futuregrams website. At opening time, a virtual worker could send another post or message to the social media platform via its respective API indicating that futuregram is now available for inspection.

The foregoing merely illustrates the principles of the invention. It will thus be appreciated that those skilled in the art will be able to devise various arrangements which, although not explicitly described or shown herein, embody the principles of the invention and are thus within its spirit and scope. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and it does not imply any particular range of number of elements; that is, a plurality of elements can be as few as two elements, and can include an immeasurable number of elements.

We claim:

1. A computer-implemented method for creating and sending an electronic message that can only be opened at a specified time in the future, comprising:
receiving input from a user to select one or more recipients;
receiving input from the user regarding contents of the electronic message;
receiving input from the user regarding an opening time, wherein the opening time is a date and time in the future;
automatically sending a delivery notification to each of the one or more recipients, wherein the delivery notification indicates that the contents of the message can only be viewed after the opening time has passed;
automatically sending an opening time notification to each of the one or more recipients at the opening time, wherein the opening time notification indicates that the contents of the message can now be viewed; and
automatically providing the contents of the message to the one or more recipients.

2. The method of claim 1, wherein the contents of the electronic message comprise at least two of text, an image, audio, and video.

3. The method of claim 1, further comprising:
receiving input from the user to select a theme from a collection of predefined themes, wherein each of the predefined themes defines a different graphical presentation of the message.

4. The method of claim 1, further comprising:
receiving input from the user regarding a delivery time, wherein the delivery time is a date and time in the future that precedes the opening time, and wherein the step of sending the delivery notification occurs at the delivery time.

5. The method of claim 1, further comprising:
receiving input from the user regarding anonymity, wherein if the user desires to be anonymous, the message will not identify the user to the one or more recipients.

6. The method of claim 1, further comprising:
receiving input from the user regarding privacy, wherein if the user indicates that the message should be private, only the one or more recipients may view the delivery notification, the opening notification, and the message; and wherein if the user indicates that the message should be public, all users may view the delivery notification, the opening notification, and the message.

7. The method of claim 1, further comprising:
receiving input from the user to define a rule, wherein the rule requires the occurrence of an event, and the opening time is based on the occurrence of the event.

8. The method of claim 1, further comprising:
receiving input from the user to edit the contents of the message after the delivery time but before the opening time.

9. The method of claim 8, further comprising automatically sending a change notification to the one or more recipients when the user edits the contents of the message.

10. The method of claim 1, further comprising:
receiving input from the user regarding one or more hints to the contents of the message;
receiving input from one of the recipients to request one of the hints; and
automatically sending a hint notification to the requesting recipient, wherein the hint notification comprises one of the hints.

11. A system for creating and sending an electronic message that can only be opened at a specified time in the future, comprising:
a plurality of client devices, wherein each client device comprises client software configured to:
receive input from a user to select one or more recipients;
receive input from the user regarding contents of the electronic message;
receive input from the user regarding an opening time, wherein the opening time is a date and time in the future;
a server system comprising a data repository, wherein the server system is configured to:
automatically send a delivery notification to each of the one or more recipients, wherein the delivery notification indicates that the contents of the message can only be viewed after the opening time has passed;
automatically send an opening time notification to each of the one or more recipients at the opening time, wherein the opening time notification indicates that the contents of the message can now be viewed; and
automatically provide the contents of the message to the one or more recipients.

12. The system of claim 11, wherein the contents of the electronic message comprise at least two of text, an image, audio, and video.

13. The system of claim 11, wherein the client software is further configured to receive input from the user to select a theme from a collection of predefined themes, wherein each of the predefined themes defines a different graphical presentation of the message.

14. The system of claim 11, wherein the client software is further configured to receive input from the user regarding a delivery time, wherein the delivery time is a date and time in the future that precedes the opening time; and wherein the server system is further configured to automatically send the delivery notification at the delivery time.

15. The system of claim 11, wherein the client software is further configured to receive input from the user regarding anonymity, wherein if the user desires to be anonymous, the message will not identify the user to the one or more recipients.

16. The system of claim 11, wherein the client software is further configured to receive input from the user regarding privacy, wherein if the user indicates that the message should be private, only the one or more recipients may view the delivery notification, the opening notification, and the message; and wherein if the user indicates that the message should be public, all users may view the delivery notification, the opening notification, and the message.

17. The system of claim 11, wherein the client software is further configured to receive input from the user to define a rule, wherein the rule requires the occurrence of an event, and the opening time is based on the occurrence of the event.

18. The system of claim 11, wherein the client software is further configured to receive input from the user to edit the contents of the message after the delivery time but before the opening time.

19. The system of claim 18, wherein the server system is further configured to automatically send a change notification to the one or more recipients when the user edits the contents of the message.

20. The system of claim 11, wherein the client software is further configured to:
receive input from the user regarding one or more hints to the contents of the message; and
receive input from one of the recipients to request one of the hints; and
wherein the server system is further configured to automatically send a hint notification to the requesting recipient, wherein the hint notification comprises one of the hints.
